(19) United States
(12) Patent Application Publication
(10) Pub. No.: US 2018/0236303 A1
(43) Pub. Date: Aug. 23, 2018

(54) Golf Ball, System, and Method For Locating A Golf Ball

(71) Applicants: inTras-Golf UG (haftungsbeschraenkt) & Co. KG, Netphen (DE); Fraunhofer-Gesellschaft zur Foerderung der angewandten Forschung e.V., Munchen (DE)

(72) Inventors: Fabian Mathar, Berlin (DE); Christian Tschoban, Gross Kreutz (DE); Julia Guenther, Berlin (DE); Kai Schrank, Niedergoersdorf (DE); Irene Schuerz, Ebersbach an der Fils (DE); Roland Schuerz, Ebersbach an der Fils (DE); Helga Morgenschweis, Netphen-Herzhausen (DE); Bernd Morgenschweis, Netphen-Herzhausen (DE)

(21) Appl. No.: 15/753,398

(22) PCT Filed: Jul. 26, 2016
(86) PCT No.: PCT/EP2016/067787

§ 371 Date: Feb. 19, 2018

(30) Foreign Application Priority Data
Aug. 20, 2015 (DE) 10 2015 113 809.3

(51) Int. Cl. A63B 24/00; A63B 37/00; A63B 43/00; A63B 69/36; A63B 71/06; H01Q 1/22; H01Q 1/40; H01Q 9/42; G01S 19/19; G01S 19/34; G01S 19/48; G01S 5/00

(52) U.S. Cl. CPC A63B 24/0021; H04W 4/029; A63B 37/0076; A63B 43/004; A63B 69/3658; A63B 71/0619; H01Q 1/22; H01Q 1/40; H01Q 9/42; G01S 19/19; G01S 19/34; G01S 19/48; G01S 5/0027; A63B 2220/12; A63B 2220/35; A63B 2220/40; A63B 2225/54; A63B 2024/0028; A63B 2024/0031; A63B 2024/0034; A63B 2024/0053; A63B 37/0055

(57) ABSTRACT

The invention relates to a golf ball (1), which has at least one transmitting and receiving antenna (10) and a position determination unit (11), which has a communicative connection to the transmitting and receiving antenna (10) and is designed to receive GPS data, which specify the position of the golf ball (1). Furthermore, the golf ball has a communication unit (12), which has a communicative connection to the transmitting and receiving antenna (10) and is designed to transmit radio data, in particular the position of the golf ball (1). In addition, the golf ball has at least one charging coil (14), which is connected to an energy store (13) and is designed to charge the energy store (13) by means of inductive energy transmission. Moreover, the invention relates to a method for locating an object, in particular a ball-like object, for example, a golf ball, and a transmitting and receiving antenna for use in such a ball-like object.

The present invention relates to a golf ball, and also to a system and a method for locating an object, in particular a golf ball.

When playing golf, the problem frequently occurs of again finding a ball which has been struck. Because of the size of the golf ball and the distance which it covers due to a stroke, it is often not possible for the player to accurately track the position of the golf ball from the striking location. If a golf ball additionally lands in high grass or other terrain having obstructed view, finding it is frequently made more difficult in that the game and that of the following players is strongly delayed because of the search in spite of the established maximum searching time, or the golf ball is no longer found at all. There is therefore a demand for a golf ball which can be electronically located. However, there is also a demand for a precise locating method for locating objects in agriculture (for example, marked plants or animals) and in industrial logistics (for example, objects on construction sites).

The systems known in the prior art are perceived to be unsatisfactory. A golf ball having integrated GPS unit is known from DE 101 43 588 A1, by means of which the position of the golf ball is determined. The accuracy of the location determination thus achieved is not sufficient, however, to reliably locate the golf ball in rough terrain. Systems are also known in which the golf ball is located by means of radio direction finding. These systems have a limited range, which is usually not sufficient to determine the location of the golf ball immediately after a stroke. The player therefore firstly has to visually determine the approximate location of the golf ball, to perform the locating from an approximated position. If the visual localization is obstructed, for example, on a hilly golf course, this can result in a loss of the golf ball. The loss of a ball has a substantial influence on the golf game. The player thus has to decide whether he wishes to play a provisional ball. If so, a provisional ball is played with the corresponding time expenditure. This decision typically requires time, since it is often unclear whether the ball is actually lost or is still playable.

The object of the present invention is to improve conventional systems for finding a golf ball and existing methods for locating objects. The system is to be robust, precise, and easily usable. In particular, a golf ball is to be specified in consideration of the mentioned problems, the locating of which is possible during the entire stroke and in which the accuracy of the locating is improved.

This object is achieved by a device according to Patent claim 1, and by a system according to Patent claim 12 and a method according to Patent claim 15.

In particular, the object is achieved by a golf ball, which has the following:
at least one transmitting and receiving antenna;
a position determination unit, which has a communicative connection to the transmitting and receiving antenna and is designed to receive GPS data which specify the position of the golf ball;
a communication unit, which has a communicative connection to the transmitting and receiving antenna and is designed to transmit radio data, in particular the position of the golf ball and/or acceleration data and/or gyroscopic data;
at least one charging coil, which is connected to an energy store and is designed to charge the energy store by means of inductive energy transfer.

An essential point of the invention is that for locating an object, in particular the golf ball, multiple locating concepts are combined, so that, on the one hand, locating over long distances and, on the other hand, sufficiently accurate locating at short distances are enabled. The systems use a common transmitting and receiving antenna in this case. An optimum locating ability of the golf ball is thus ensured, without exceeding the predefined weight and the predefined size of the golf ball.

In one embodiment, the golf ball has an inner core, in which the position determination unit, the communication unit, and the energy store are arranged. Due to the arrangement of the electronic components in the inner core, it is possible to select a multilayer structure typical for golf balls. Moreover, the inner core fulfills a protective function, by protecting the electronic components from mechanical effects, to which the golf ball is subjected when it is hit.

In a (further) embodiment, the inner core consists of a plastic having nubs as a twist lock. The position determination unit, the communication unit, and the energy store are embedded in the inner core. An optimum protection of the electronic components is thus ensured. Alternatively, the electronic components can be jacketed, for example, extrusion coated, using plastic.

In a (further) embodiment, at least one transmitting and receiving antenna is arranged on the surface of the inner core, in particular adhesively bonded or printed thereon. This enables a simple and cost-effective production of the golf ball. The transmitting and receiving antenna can be printed in this case via inlay printing on the inner core. The transmitting and receiving antenna is integrally connected to the inelastic inner core due to the printing. The transmitting and receiving antenna is thus not subjected to strong deformations in the event of mechanical load. Moreover, the shielding by further external material of the golf ball is reduced by the surface-proximal arrangement of the transmitting and receiving antenna.

In an alternative embodiment, the transmitting and receiving antenna is embedded in the inner core close to the surface. The transmitting and receiving antenna is preferably embedded 0.5 to 1 mm distant from the surface of the inner core. The mechanical carrying capacity of the transmitting and receiving antenna is thus further increased.

In a (further) embodiment, the transmitting and receiving antenna comprises at least two antenna units, wherein each antenna unit has a meandering structure. Each meandering shape of each antenna unit is preferably located in this case within an essentially rectangular outer contour. In an advantageous refinement of the invention, each antenna unit can have between 2 and 20 conductor loops. Antenna units having this shape can cover the frequencies required for the communication. The meandering structures of the transmitting and receiving antenna lie on a ball surface, the shape of the transmitting and receiving antenna thus essentially follows the ball shape of the golf ball.

In a (further) embodiment, the one antenna unit or the multiple antenna units of the transmitting and receiving antenna have a planar structure. They cover at least 25%, preferably at least 40%, more preferably at least 60% of the surface of the inner core. The planar design of the antenna units facilitates the printing onto the inner core. The transmitting and receiving properties thereof are improved by the large area of the transmitting and receiving antenna.

In one (preferred) embodiment, the transmitting and receiving antenna comprises two antenna units. These are arranged on the inner core so that the inner core is located between the antenna units and the antenna units lie opposite to one another. It is thus ensured that the golf ball cannot come to rest in a position in which the transmitting and receiving antenna is shielded by the golf ball itself. The two antenna units can be arranged with point symmetry with respect to the center point of the inner core, or with mirror symmetry with respect to a plane which extends through the center point of the inner core.

The area covered by an antenna unit can be between 1 and 2.5 cm².

In a (further) embodiment, the golf ball comprises a sensor unit for acquiring measured values, wherein the sensor unit has a communicative connection to the transmitting and receiving antenna. Data relevant to the player can thus be measured during the flight of the golf ball and provided to the mobile terminal for further processing and display.

In a (further) embodiment, the sensor unit comprises at least one acceleration sensor and at least one rotation rate sensor. Using data acquired by these sensors, the flight curve of the golf ball can also be computed, which can be provided as continuing information to the user, on the one hand, and can be used as the foundation for the locating of the golf ball during the flight, on the other hand.

In a (further) embodiment, the at least one charging coil is arranged on the inner core such that the area enclosed by the charging coil does not overlap with the areas covered by the transmitting and receiving antenna. Therefore, interference between the at least one charging coil and the transmitting and receiving antenna can be suppressed. It is thus ensured that the transmitting and the receiving of data via the transmitting and receiving antenna is not impaired by the charging coil. It is therefore preferable for the antenna units of the transmitting and receiving antenna to cover at most 80%, more preferably at most 70%, more preferably at most 60% of the surface of the inner core.

Furthermore, a system for locating a golf ball is specified in the scope of the invention, which uses a golf ball according to the invention and furthermore comprises a mobile terminal, which is designed for the purpose of receiving the radio data transmitted by the golf ball. This provides a practical solution to the player for tracking the position of the golf ball during the game and also locating its precise location after the landing and/or rolling,

In one embodiment, the mobile terminal comprises a display screen, on which the position of the golf ball is displayable. This enables the indications of the golf ball position to be combined with a map of the golf course, so that the player can easily ascertain the position of the golf ball. The player can thus already recognize at the striking location, for example, whether the golf ball was hit into the rough, so that he can decide to play a so-called provisional second ball thereafter. In one preferred embodiment, the mobile terminal also comprises a position determination unit, by means of which the position of the mobile terminal can be ascertained via GPS. The distance between the player and the struck golf ball can thus be ascertained.

In a (further) embodiment, the mobile terminal comprises a memory, on which data received from the golf ball are storable. This can comprise both the positions transmitted by the golf ball and also sensor data. These data can be used to indicate the flight path and/or the flight velocity of the golf ball to the player after a stroke. The number of the required strokes at a hole can also be ascertained. In addition, a history present on the memory of the data transmitted by the golf ball can be used to analyze the game of a player and to evaluate a development of the player over multiple parties.

Furthermore, a method for locating a golf ball is specified in the scope of the invention, which uses the system according to the invention for locating a golf ball and comprises the following steps:
GPS locating of the golf ball (1) on the basis of the GPS data transmitted by the golf ball (1)
switching to local locating (near field communication) as soon as the mobile terminal (20) and the golf ball (1) fall below a distance required for local locating.

In the scope of the invention, a method for locating an object, in particular a golf ball, is additionally/alternatively specified, wherein the object has
at least one transmitting and receiving antenna;
a position determination unit, which has a communicative connection to the transmitting and receiving antenna and is designed to receive GPS data, which specify the position of the object;
a communication unit, which has a communicative connection to the transmitting and receiving antenna and is designed to transmit radio data, in particular the position of the object;
an energy store, which is connected in particular to a charging coil, which is designed to charge the energy store by means of inductive energy transfer; comprising the following steps:
GPS locating of the object on the basis of the GPS data transmitted by the object by means of a mobile terminal, which is designed to receive the radio data transmitted from the object, and which in particular comprises a display screen, on which the position of the object is displayable;
switching to local locating (for example, near field communication), as soon as the mobile terminal and the object fall below a distance required for local locating.

To avoid repetitions, functional elements and functional units or features of the golf ball according to the invention, respectively, which were already described above and which are similarly usable for an object to be located are not described again.

The above statements, in particular with respect to features, effects, and advantages, on the transmitting and receiving antenna, the position determination unit, the communication unit, and the energy store of the golf ball according to the invention correspondingly apply equivalently to the transmitting and receiving antenna, the position determination unit, the communication unit, and the energy store of the object.

Using the locating method according to the invention, it is possible to achieve a long range of the locating, on the one hand, while the accuracy of the locating is improved when the player approaches the golf ball, for example.

In addition to the use in playing golf, the locating method according to the invention can also be used in industrial logistics (for example, on construction sites) or in agriculture (for example, for animal monitoring or in plant production).

In the scope of animal monitoring, at least one animal to be monitored (for example, a chicken, a sheep, a cow), which, in conjunction with the required signal unit (transmitting and receiving antenna, position determination unit, communication unit, energy store, etc.) represents the object and/or the object to be located in the scope of the invention, also in free-range farming and upon grouping (for example, in a herd), can be located reliably and accurately, even if it stands very close together with other animals. Thus, for example, GPS locating (coarse locating) can be performed with the aid of the GPS data on the field and subsequently it is also possible to differentiate between animals standing very close together by means of local locating (fine locating).

The method can similarly be used for monitoring at least one plant (for example, before and after the harvest), which, in conjunction with the mentioned signal unit, also represents the object in the scope of the invention. On the basis of the coarse locating, for example, extensive fields and forests may be monitored, and even small plants may be differentiated and/or harvested wood in a cord may be detected and/or ascertained by means of the fine locating.

In a further embodiment, the method additionally comprises the following steps:
determining the position of the object located in flight, in particular a golf ball, from GPS data transmitted by the object
computing the flight path of the object, in particular a golf ball, from sensor data ascertained, in particular measured, upon beginning of movement (for example, firing in the case of ignition of the propellant charge) and/or beginning of flight, in particular upon striking, and/or during the flight (for example, on acceleration, rotation, direction)
ascertaining a computed landing position of the object from the computed flight path
comparing the computed landing position of the object to GPS data transmitted during the flight

By way of the computed landing position of the object, for example, a golf ball, an approximate position of the object can also be ascertained if the object has been moved and/or struck so far that the range of the radio connection between mobile terminal and object is exceeded. The accuracy of this prediction is further increased by the comparison of the computed landing position to GPS data received during the flight. As soon as the mobile terminal comes back into the range of the object and receives data transmitted thereby, the position determination again takes place on the basis of the GPS data transmitted by the object.

In a (further) embodiment, the method for locating a golf ball furthermore comprises a comparison of the computed or located landing position of the golf ball to present golf rules and/or individual course rules, to establish whether the golf ball is “in” or “out”. Suggestions and/or recommendations for action for measures which are possibly required can be derived from the comparison of the position of the golf ball to present golf rules and/or individual course rules. The recommendation can be output, for example, to play a further ball from the present position if it is determined that the previously struck golf ball is “out”. The flow of play is thus further improved.

In the scope of the invention, furthermore a transmitting and receiving antenna for a ball-like object, in particular a ball, is specified, which in particular has a ball-like inner core, wherein the transmitting and receiving antenna is formed as ellipsoidal, in particular spherical, at least in sections, and in particular has at least two antenna units, wherein preferably each antenna unit has a meandering structure and/or the two antenna units are preferably formed essentially symmetrically, in particular point symmetrically.

In a further embodiment, the transmitting and receiving antenna for a ball-like object, in particular the at least two antenna units, has a planar structure, and/or the transmitting and receiving antenna covers at least 25%, preferably at least 40%, more preferably at least 60% of the surface of the ball-like object and/or the surface of the ball-like inner core of the ball-like object.

In a further embodiment, the transmitting and receiving antenna for a ball-like object is embedded in the ball-like core close to the surface of the core, in particular 0.5 mm to 1.5 mm distant from the surface, or the transmitting and receiving antenna is suitable to be arranged, in particular adhesively bonded, on the surface of the core and/or on the surface of the ball-like object.

To avoid repetitions, functional elements and functional units and/or features of the transmitting and receiving antenna of the golf ball according to the invention which were already described above and which are similarly usable for the transmitting and receiving antenna of a ball-like object are not described once again.

The above statements, in particular with respect to features, effects, and advantages, on the transmitting and receiving antenna of the golf bail according to the invention accordingly apply equivalently to the transmitting and receiving antenna according to the invention of a ball-like object.

A ball-like object is to be understood as an object, the shape of which essentially or identically corresponds to and/or is the shape of, for example, a ball (for example, a truncated icosahedron), a capsule (halved ball, in the middle of which a cylinder having equal radius was inserted in a fitted manner) in particular having a small height of the cylindrical part, an ellipsoid, and/or an egg.

Due to the ellipsoidal (shaped like an ellipsoid), in particular spherical formation at least in sections of the transmitting and receiving antenna, the transmitting and receiving antenna can follow the shape of the surface of the ball-like object and/or the ball-like core and thus efficiently use the space occupied by the object and/or occupy as little additional space as possible.

The transmitting and receiving antenna according to the invention can be used, inter alia, in medical technology (for example, in free-floating endoscopes), in mechanical engineering (for example, in balls of bearings), in objects for monitoring procedural processes (for example, in biogas plants, breweries, or ball mills), or in objects for ballistic studies.

In one embodiment, the above-described golf ball is used and/or employed in a simulation system, in particular in a golf simulation system. With the aid of the sensors in the golf ball, the stroke and/or the flight path of the golf ball can be acquired in great detail. On the basis of the items of information thus obtained, the simulation system according to the invention can compute and display a (theoretical/simulated) flight path. In one embodiment of the invention, the flight path is displayed on the described (mobile) terminal. In one embodiment, the display can be performed such that the flight path of a virtual golf ball within a virtual environment, for example, a virtual representation of a golf course, is visualized. This visualization can take place on the terminal and/or a projection screen of the simulation system. Upon the use of a projection screen and/or any arbitrary other display device, for example, a large-format display screen, a very realistic simulation is supplied to the user.

In one embodiment, the above-described app is used on the terminal to evaluate the stroke and/or the flight path. A large-area representation can be carried out by connecting a corresponding projector and/or a large-format display screen. Alternatively, the analyzed data can be transmitted in a wireless and/or wired manner to a further computer unit for display.

The described simulation system has substantial price advantages in relation to conventional indoor facilities.

Further embodiments of the invention result from the dependent claims.

The invention will be described hereafter on the basis of exemplary embodiments, which are explained in greater detail on the basis of the figures. In the figures:

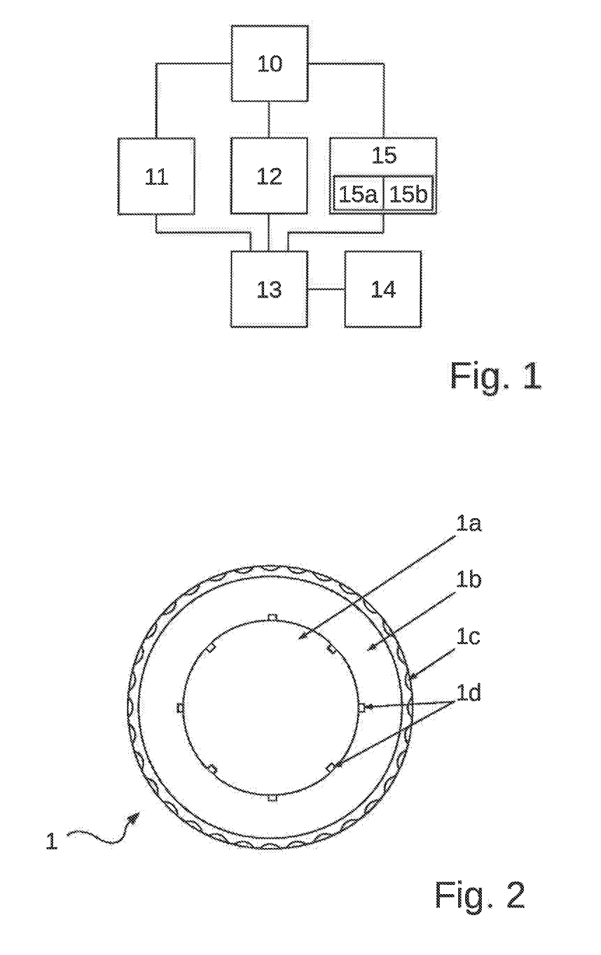

FIG. 1 shows a connection scheme, which schematically shows the electronic components and the connections thereof in a golf ball according to one exemplary embodiment of the invention;

FIG. 2 shows a section, which shows the multilayer structure of the golf ball according to one exemplary embodiment of the invention;

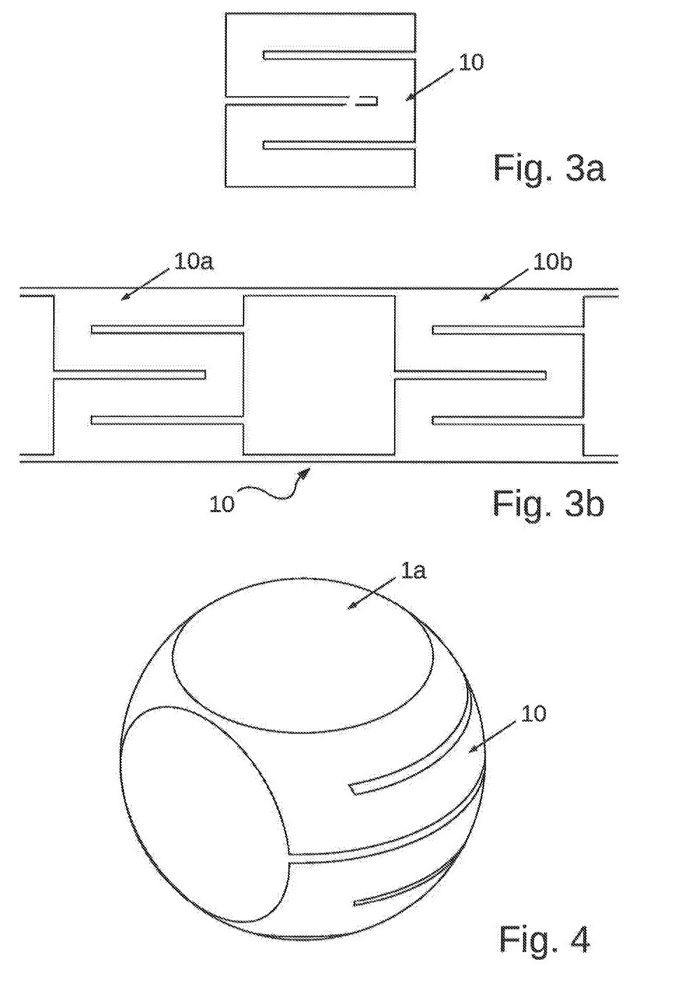

FIG. 3a shows a schematic view of a layout for a transmitting and receiving antenna unit according to one exemplary embodiment of the invention;

FIG. 3b shows a schematic view of a layout for a transmitting and receiving antenna having two antenna units;

FIG. 4 shows a perspective view of an inner core of a golf ball, on which the transmitting and receiving antenna is applied;

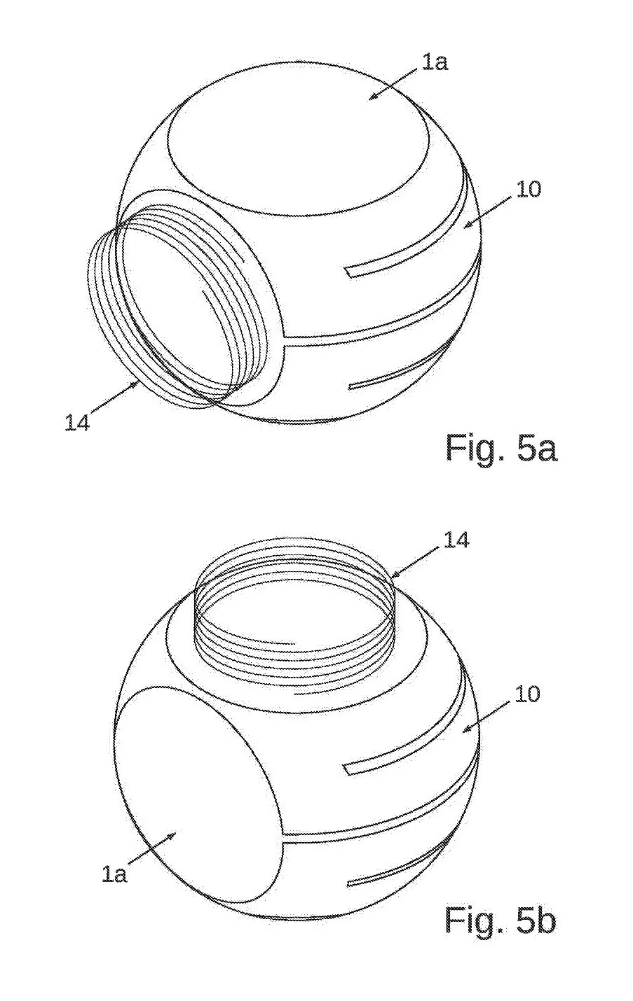

FIG. 5a shows a perspective view of the inner core of the golf ball, in which a possible placement of a charging coil with respect to the transmitting and receiving antenna is shown;

FIG. 5b shows a perspective view of the inner core of the golf ball, in which another possible placement of a charging coil with respect to the transmitting and receiving antenna is shown.

The same reference signs are used for identical and identically acting parts in the following description.

FIG. 1 is a connection scheme, which shows the electronic components and the connections thereof in a golf ball 1 according to one exemplary embodiment of the invention. The golf ball 1 has a transmitting and receiving antenna 10. It is used to receive data to determine the position of the golf ball 10. The transmitting and receiving antenna 10 is therefore connected to a position determination unit 11, which is formed in the present exemplary embodiment by a commercially available GPS module. An internal antenna of the position determination unit 11 can be omitted in this case. This reduces the power consumption and saves both weight and also structural space.

The transmitting and receiving antenna 10 is used, on the other hand, for the purpose of transmitting radio data to a user. The transmitting and receiving antenna 10 is therefore connected to a communication unit 12, which provides and transmits the radio data to be transmitted. The golf ball 1 furthermore has a sensor unit 15. The sensor unit 15 comprises an acceleration sensor 15a and a rotation rate sensor 15b. The golf ball 1 additionally has an energy store 13, which supplies the electronic components in the golf ball 1 with electrical energy. The energy store 13 is formed in the present exemplary embodiment by a rechargeable battery, the capacity of which is sufficient to supply the electronic components of the golf ball 1 with an operating voltage of 3 V for 6.5 hours.

FIG. 2 is a section, which shows the multilayered structure of the golf ball 1 according to one exemplary embodiment of the invention. The golf ball 1 consists of an inner core 1a, which is enclosed by an elastic jacket 1b. The outermost layer of the golf ball 1 is formed by the outer envelope 1c.

The inner core 1a consists of a hard plastic material, having individual nubs 1d to the inside and outside as a twist lock, and is used for protecting the above-described electronic components. These are therefore embedded in the inner core 1a. The arrangement of the electronic components in the inner core 1a is selected so that the center of gravity of the inner core 1a is coincident with its geometric center point, so that the flight properties of the golf ball 1 are not impaired. The density of the material used is similar in this case to the density of the embedded electronic components, to ensure a uniform weight distribution in the interior of the core.

The elastic jacket 1b is formed from a rubber material. The elastic jacket 1b absorbs the energy of the stroke and conducts it around the inner core 1a. The deformation of the golf ball 1 during the stroke is thus primarily implemented by the elastic jacket 1b, wherein the components located in the inner core 1a are well protected. The elastic jacket 1b can consist of multiple layers of material, to improve the play properties or the dissipation of the energy of the stroke around the inner core 1a of the golf ball.

The outer envelope 1c is a hard plastic shell, which has dimples to improve the flight properties of the golf ball 1. The diameter of a rule-consistent golf ball 1 has to be at least 42.67 mm, while the weight cannot exceed 45.93 g. The weight of the inner core can be limited to approximately 16 g by the weight savings which result from the use of the common transmitting and receiving antenna 10.

Since the GPS signal usable by civilians has a frequency of 1575.42 MHz and the SRD band Europe at 868 MHz is used for the communication with the mobile terminal, the transmitting and receiving antenna 10 is designed as a multiband antenna, The multiband antenna 10 consists of two antenna units 10a, 10b, which have a planar structure. A schematic view of an antenna unit of the transmitting and receiving antenna 10 is shown in FIG. 3. The antenna unit is meandering and consists of conductor loops extending in parallel. The loop guiding follows an essentially rectangular outer contour. The multiband antenna consists of two antenna units 10a, 10b, the schematic layout of which is illustrated in FIG. 3b. The antenna units 10a, 10b are connected to one another by connection webs. If the dimensions of the planar layout shown in FIG. 3b are selected suitably, the multiband antenna 10 can be printed directly on the inner core 1a of the golf ball 1. The dimensions are selected in this case so that the connection webs, which extend beyond the two antenna units 10a, 10b, are connected to one another during the printing, so that the multiband antenna 10 spans the complete inner core 1a and the antenna units 10a and 10b lie opposite to one another with respect to the inner core 1a. An inner core 1a thus printed is shown in a perspective illustration in FIG. 4. The configuration having two antenna units 10a, 10b offers the advantage in this case that the golf ball 1 cannot come to rest in a position in which the communication with the GPS satellites or the transmission function of the communication unit 11 is suppressed in that the golf ball 1 shields the multiband antenna 10. It is also ensured during the flight that one of the antenna units 1a, 10b always faces toward the player, which facilitates the transmission of the radio data.

As can be seen in FIG. 4, four essentially circular areas are formed on the inner core 1a by the design of the multiband antenna 10, which are not covered by the multiband antenna 10. The arrangement of the charging coil 14 in the golf ball 1 is selected so that the charging coil 14 does not interfere with the multiband antenna 10. Two of the possible arrangements for the charging coil 14 are schematically shown in FIGS. 5a and 5b. The charging coil 14 can be arranged in this case on the surface of the inner core 1a or embedded close to the surface in the inner core 1a. Multiple charging coils 14 can also be provided.

To charge the golf ball 1, a charging station (not shown) is provided, which has a primary coil, via which energy is transferred to the charging coil 14 located in the golf ball 1 by induction. The charging station has a depression, which essentially has the shape of a hemisphere and in which the golf ball 1 inserted for charging. The primary coil of the charging station is attached on the circumference of the hemispherical trough or is formed as spherical and is provided in the hemispherical depression of the charging station and encloses the golf ball 1 and the charging coil 14 located therein. The golf ball 1 has a marking on its outer envelope 1c, which enables the golf ball 1 to be inserted into the charging station so that the charging coil 14 and the primary coil are arranged essentially concentrically. The energy transfer is thus improved and the charging time is shortened. The charging coil 14 can be optimized with the aid of additional ferrites to optimize the charging procedure.

For locating the described golf ball 1, a system is used, which, in addition to the golf ball 1, comprises a mobile terminal 20, using which the data transmitted by the communication unit 12 can be received. The mobile terminal 20 has a display screen, on which the position of the golf ball 1 is displayed together with a terrain map of the golf course. The mobile terminal 20 also comprises a GPS module, so that the position of the player can also be displayed on the map.

The position of the golf ball 1 is determined using the GPS unit 11 and transmitted to the mobile terminal 20. The range of the radio connection between golf ball 1 and mobile terminal 20 is between 300 and 500 m in the ideal case. In rough terrain, the range is accordingly less. Furthermore, an approximate flight curve of the golf ball 1 is computed on the basis of the data ascertained by the sensor unit 15. This approximate flight curve can already be ascertained and transmitted while the golf ball 1 is in flight. It is thus possible to display to the player the approximate flight path of the golf ball 1 and an approximate landing location immediately after the stroke. The computed flight path is compared in this case to the GPS data, to increase the accuracy. For the case in which the connection between golf ball 1 and mobile terminal 20 is interrupted, an approximate position determination already takes place due to the computed landing location. If the connection between golf ball 1 and mobile terminal 20 is interrupted, both the last position ascertained by means of GPS and also the computed landing location are available. If the golf ball 1 lands, for example, in a water hazard, such an interruption can occur. The last position ascertained via GPS can then be used to determine at which point the golf ball 1 has entered the water hazard. If the golf ball 1 has landed outside the range of the mobile terminal 20, but is still capable of transmitting data, the locating via GPS can take place again as soon the mobile terminal 20 is again within the range of the golf ball 1.

The accuracy of the GPS locating is approximately 1 m. If the player approaches the golf ball 1 with the mobile terminal 20, as soon as the resolution of the GPS locating is no longer sufficient, it switches over to local locating between golf ball 1 and mobile terminal 20.

The local locating can be carried out by means of a/the 868 MHz interface of the golf ball 1. At least one IC of the golf ball 1 can transmit a signal, which can be used for the local locating of the golf ball 1.

Alternatively or additionally, it is possible that the local locating is carried out, for example, by means of near field communication (NFC). For the near field communication, a transponder can be provided in the golf ball 1, which establishes a connection to the mobile terminal 20 upon entry of the mobile terminal 20 into its range. The near field communication can also be carried out by an analysis of the signal strength of the signal emitted by the communication unit 12. If the mobile terminal 20 has a GPS unit, point locating by comparison of the GPS data received by the golf ball 1 and the mobile terminal 20 can also be used to carry out the locating. It is only decisive in this case that the accuracy of the locating by means of near field communication is 10 cm or less, so that the player can reliably find the golf ball 1.

The invention was described on the basis of a specific exemplary embodiment. In addition, various modifications are possible without deviating from the concept of the invention.

The components of the position determination unit 11, the communication unit 12, and the sensor unit 15 can be formed completely or partially on a common circuit board. They can be partially formed by software modules, which are available on a common memory. A microprocessor unit can be provided for the activation and data processing of the individual functional elements, such as GPS locating, radio communication, and energy supply. The circuit board can be embodied in Starflex/Flex technology, which enables the circuit board to fold in order to correspond to the small space budget.

The sensor unit 15 can comprise, in addition to the mentioned sensors, an inertial sensor, a magnetic field sensor, a force sensor, a pressure sensor, and/or a bearing sensor (gyroscope), and also a temperature sensor, by means of which further items of information relevant to the player are measured. The flight velocity upon striking and the rotation of the golf ball 1 during the flight can be used, for example, to conclude the position of the golf club, at which the golf club has hit the golf ball 1. In general, the evaluation of the sensor data can take place in the sensor unit 15 of the golf ball 1, so that the quantity of data to be transmitted to the mobile terminal 20 is reduced. Alternatively, the sensor data can be transmitted unprocessed and the evaluation can take place in the mobile terminal 20.

To be able to use multiple golf balls 1 according to the invention in a party or in a flight, the golf ball 1 can have a unique electronic identification or identifier, by means of which it can be uniquely associated with a mobile terminal 20.

The data transmission from the golf ball 1 to the mobile terminal can be performed cyclically, for example, at a frequency of 1 Hz.

A device conceived separately for the application can also be provided as the mobile terminal 20 by the selection of the radio frequency of a mobile telephone or smart phone. The mobile terminal 20 can also be formed by a watch or a device wearable on the wrist. Alternatively, the display screen for the display can be housed in such a device, which has a radio connection to the mobile terminal 20. In this case, the mobile terminal 20 transmits the display data to the display device. The information to be displayed about the position of the golf ball 1 is thus easily visible to a user, without him having to hold the mobile terminal 20 in the hand.

The mobile terminal 20 can be equipped by the installation of an app such that it can communicate with the golf ball 1 according to the invention. In this context, the app (for example, on a smart phone) can be equipped for the purpose of assisting the player in finding the golf ball 1.

Furthermore, all measured values already described and further measured values can be received by the app and displayed to the player in a suitable format. The app can be used for this purpose, in order to collect and analyze received raw data, for example, a plurality of position specifications in the course of the flight of the golf ball 1. Measured values such as the acceleration upon the stroke, the flight duration, the flight course, and the velocity and/or the velocity curve during the flight can be ascertained on the part of the app.

The app can use some or all of these measured values to improve the game of the player with helpful instructions. In the final effect, the app can assume a type of interactive coaching. For this purpose, it is possible that the app communicates with further units or devices. For example, a communication can take place with a specially equipped training golf club.

It is possible according to the invention that the app queries and/or stores items of information about the golf course. These items of information can be used to improve the game of the player. Furthermore, these items of information can be used to compare the ascertained ball location with permitted positions (“in” or “out”). These items of information can also be used to ascertain the playability of a specific ball rapidly and easily. The app thus essentially contributes, in conjunction with the system and/or golf ball 1 according to the invention, to accelerating the flow of play. The player can decide rapidly whether he gives up on a specific ball or not. Furthermore, special (individual) course suggestions and/or the movement options corresponding to the ball position or also required measures (inter alia, penalty strokes) according to the rules of the game can be displayed via this app. This also facilitates and accelerates the play substantially and moreover assists the player in the rules of the game.

Furthermore, the app can be equipped for the purpose of using the measured values and/or positions of the golf ball 1 to perform a judgment of the game. It is possible to share this judgment with other players, so that a digital ranking is possible.

### LIST OF REFERENCE NUMERALS

1 golf ball
1a inner core
1b elastic jacket
1c outer envelope
1d nubs
10 transmitting and receiving antenna
10a first antenna unit
10b second antenna unit
11 position determination unit
12 communication unit
13 energy store
14 charging coil
15 sensor unit
15a acceleration sensor
15b rotation rate sensor
20 mobile terminal

1. A golf ball (1), which has the following:
at least one transmitting and receiving antenna (10);
a position determination unit (11), which has a communicative connection to the transmitting and receiving antenna (10) and is designed to receive UPS data which indicate a position of the golf ball (1);
a communication unit (12), which has a communicative connection to the transmitting and receiving antenna (10) and is designed to transmit radio data, including the position of the golf ball (1);
at least one charging coil (14), which is connected to an energy store (13) and is designed to charge the energy store (13) by means of inductive energy transfer.

2. The golf ball (1) according to claim 1, characterized by:
an inner core (1a), in which the position determination unit (11), the communication unit (12), and the energy store (13) are arranged.

3. The golf ball (1) according to claim 1 characterized by:
the inner core (1a) comprising a plastic having nubs on at least one of an inner side and an outer side of an inner core shell as a twist lock (1d), and the position determination unit (11), the communication unit (12), and the energy store (13) are embedded in the inner core (1a).

4. The golf ball (1) according to claim 2, characterized by:
the at least one transmitting and receiving antenna (10) is arranged on the surface of the inner core (1a) by one of adhesively bonding and printing.

5. The golf ball (1) according to claim 2, characterized by:
the transmitting and receiving antenna (10) is embedded in the inner core (1a) in a range of 0.5 mm to 1.5 mm from the surface.

6. The golf ball (1) according to claim 1, characterized by:
the transmitting and receiving antenna (10) has at least two antenna units (10a, 10b), wherein each antenna unit (10a, 10b) has a meandering structure.

7. The golf ball (1) according to claim 6, characterized by:
the at least two antenna units (10a, 10b) of the transmitting and receiving antenna (10) have a planar structure and cover at least 25%, preferably at least 40%, more preferably at least 60% of the surface of the inner core (1a).

8. The golf ball (1) according to claim 6, by:
the two antenna units (10a, 10b) are arranged on the inner core (1a) so that the inner core (1a) is located between the antenna units (10a, 10b) and the antenna units (10a, 10b) lie opposite to one another.

9. The golf ball (1) according to claim 1, characterized by:
a sensor unit (15) for acquiring measured values, which has a communicative connection to the transmitting and receiving antenna (10).

10. The golf ball (1) according to claim 9, characterized by:
the sensor unit (15) including at least one acceleration sensor (15a) and at least one rotation rate sensor (15b).

11. The golf ball (1) according to claim 1, characterized by:
the at least one charging coil (14) is arranged on the inner core (1a) such that the area enclosed by the charging coil (14) does not overlap with the areas covered by the transmitting and receiving antenna (10).

12. A system for locating an object, comprising:
a golf ball (1); and
a mobile terminal (20) designed to receive radio data transmitted by the golf ball (1).

13. The system according to claim 12, characterized by:
the mobile terminal (20) comprises a display screen, on which a position of the golf ball (1) is displayable.

14. The system according to claim 12, characterized by:
the mobile terminal (20) comprises a memory, on which data received from the golf ball (1) are storable.

15. A method for locating an object (1) wherein the object (1) has:
at least one transmitting and receiving antenna (10);
a position determination unit (11), which has a communicative connection to the transmitting and receiving antenna (10) and is designed to receive GPS data which indicate a position of the object (1);
a communication unit (12), which has a communicative connection to the transmitting and receiving antenna (10) and is designed to transmit radio data including the position of the object (1); and
an energy store (13) which is connected in particular to a charging coil (14), which is designed to charge the energy store (13) by means of inductive energy transfer,
wherein the method comprises the steps of:
GPS locating of the object (1) on the basis of the GPS data transmitted by the object (1) by means of a mobile terminal (20); and
switching to local locating, as soon as the terminal (20) and the object (1) fall below a distance required for local locating.

16. The method according to claim 15, further comprising the steps of:
receiving the position of the object (1) located in flight from GPS data transmitted by the object (1);
computing the flight path of the object (1) from sensor data ascertained at beginning of movement and/or beginning of flight, in particular upon the stroke, and/or during the flight;
ascertaining a computed landing position of the object (1) from the computed flight path; and
comparing the computed landing position of the object (1) to GPS data transmitted during the flight.

17. The method according to claim 15, comprising the additional steps of:
receiving by the terminal of the radio data transmitted by the object (1); and
displaying the position of the object (1) on the terminal on a display screen of the terminal.

18. A transmitting and receiving antenna (10) for a ball-like object which has in particular a ball-like inner core (1a), comprising:
sections forming the transmitting and receiving antenna (10), the transmitting and receiving antenna (10) formed as ellipsoidal; and
at least two antenna units (10a, 10b), each antenna unit (10a, 10b) has a meandering structure and the two antenna units (10a, 10b) are symmetrical.

19. The transmitting and receiving antenna (10) according to

18, characterized in that the at least two antenna units (10a, 10b), have a planar structure and/or cover at least 25%, preferably at least 40%, more preferably at least 60% one of the surface of the ball-like object and the surface of the ball-like inner core (1a) of the ball-like object.

20. The transmitting and receiving antenna (10) according to claim 18, characterized by:
the transmitting and receiving antenna (10) is one of:
embedded in the ball-like core (1a) close to the surface of the core (1a) in the range of 0.5 mm to 1.5 mm distant from the surface; and
adhesively bonded on one of the surface of the core and the surface of the ball-like object.
